(19) United States
(12) Patent Application Publication
(10) Pub. No.: US 2026/0309491 A1
(43) Pub. Date: Oct. 8, 2026

(54) METHOD AND APPARATUS FOR DETERMINING ROUGH ROAD AND SYSTEM INCLUDING APPARATUS

(71) Applicants: Hyundai Motor Company, Seoul (KR); Kia Corporation, Seoul (KR)

(72) Inventors: Han Seon GA, Hwaseong-si (KR); Chung Hee HAN, Hwaseong-si (KR); Jin Seok SONG, Hwaseong-si (KR); Gi Heon LEE, Hwaseong-si (KR); Kweon Soo JEON, Hwaseong-si (KR); Si Hyun SEONG, Hwaseong-si (KR)

(73) Assignees: Hyundai Motor Company, Seoul (KR); Kia Corporation, Seoul (KR)

(21) Appl. No.: 19/294,621

(22) Filed: Aug. 8, 2025

(30) Foreign Application Priority Data
Apr. 4, 2025 (KR) 10-2025-0043909

(51) Int. Cl. G01C 7/04; G07C 5/04

(52) U.S. Cl. CPC G01C 7/04; G07C 5/04

(57) ABSTRACT

A method for determining a rough road, the method includes receiving, in real-time, each of a motor torque value input to a vehicle and motor revolutions per minute (RPM) measurement information output by the vehicle, determining disturbance estimation information using the input motor torque value and the motor RPM measurement information, analyzing a signal using the disturbance estimation information, and determining whether a road surface on which the vehicle travels is the rough road using a result of analyzing the signal.

### CROSS-REFERENCE TO RELATED APPLICATIONS

The present application claims benefit of priority to Korean Patent Application No. 10-2025-0043909 filed on Apr. 4, 2025 in the Korean Intellectual Property Office, the disclosure of which is incorporated herein by reference in its entirety.

### TECHNICAL FIELD

The present disclosure relates to a method and apparatus for determining a rough road, and a system including the apparatus. More specifically, the present disclosure relates to a method and apparatus capable of determining whether a road surface on which a vehicle travels is a rough road using motor Revolutions Per Minute (RPM) information of the vehicle, and a system including the apparatus.

The term “rough road” may refer to any road surface having an uneven surface, such as potholes, Belgian roads, or gravel roads, rather than a relatively smooth asphalt surface. An environment in which a vehicle travels on a rough road may significantly affect chassis-related controllers such as safety-related systems of the vehicle (for example, a traction control system (TCS)) or suspension control, and thus it may be important to determine whether a vehicle is traveling on such a rough road.

In the related art, machine learning or deep learning may often be used to determine whether a vehicle is traveling on a rough road; However, a large amount of data may be required to train an artificial intelligence model, and a long time period for training may be required.

Accordingly, there is a need to develop a method capable of robustly determining a rough road in various environments without requiring model training.

### SUMMARY

An aspect of the present disclosure is to provide a method and apparatus for determining a rough road, and a system including the apparatus.

Another aspect of the present disclosure is to provide a method and apparatus configured for determining a rough road using a motor torque command and motor Revolutions Per Minute (RPM) information without a wheel speed sensor, and a system including the apparatus.

Another aspect of the present disclosure is to provide a method and apparatus configured for determining a rough road without various pieces of prior data for training such as deep learning, machine learning or the like, and a system including the apparatus.

However, the aspects of the present disclosure are not limited to those set forth herein, and other aspects set forth herein may be more easily understood by those skilled in the art from the description below.

According to an aspect of the present disclosure, there is provided a method for determining a rough road, the method including receiving, in real-time, each of a motor torque value input to a vehicle and motor Revolutions Per Minute (RPM) measurement information output by the vehicle, determining disturbance estimation information using the input motor torque value and the motor RPM measurement information, analyzing a signal using the disturbance estimation information, and determining whether a road surface on which the vehicle travels is the rough road using a result of analyzing the signal.

The motor RPM measurement information may be received from an RPM measurement sensor.

The determining the disturbance estimation information may include outputting preliminary estimation information by inputting the motor RPM measurement information to an inverse plant model of a vehicle driving system including a motor and a wheel of the vehicle, and determining the disturbance estimation information by applying a low pass filter (LPF) to a value obtained by subtracting the input motor torque value from the preliminary estimation information. The vehicle driving system may be a system outputting a motor RPM value resulting from a predetermined torque value, when the predetermined torque value is input.

The analyzing of the signal may include performing preprocessing on the input motor torque value, and determining at least one signal characteristic using a difference between the motor torque value on which the preprocessing is performed and the disturbance estimation information.

The performing the preprocessing may include applying the LPF to the input motor torque value.

The signal characteristic may include one or more of a moving average, a variance, an amplitude, and a frequency of the signal.

The determining of whether the road surface on which the vehicle travels is the rough road may include determining the road surface as the rough road when one or more of the at least one signal characteristic, with respect to a signal value corresponding to a predetermined time window of the difference between the motor torque value on which the preprocessing is performed and the disturbance estimation information, is greater than a threshold value according to each signal characteristic.

The threshold value may be set based on a signal characteristic occurring when the vehicle travels on an asphalt road surface.

According to another aspect of the present disclosure, there is provided an apparatus for determining a rough road, the apparatus including a receiver configured to receive, in real-time, each of a motor torque value input to a vehicle and RPM measurement information output by the vehicle, a disturbance calculator configured to determine disturbance estimation information using the input motor torque value and the motor RPM measurement information, a signal analyzer configured to analyze a signal using the disturbance estimation information, and a rough road determiner configured to determine whether a road surface on which the vehicle travels is the rough road using a result of analyzing the signal.

The receiver may be configured to receive the motor RPM measurement information from an RPM measurement sensor.

In determining the disturbance estimation information, the disturbance calculator may be configured to output preliminary estimation information by inputting the motor RPM measurement information to an inverse plant model of a vehicle driving system including a motor and a wheel of the vehicle, and to determine the disturbance estimation information by applying an LPF to a value obtained by subtracting the input motor torque value from the preliminary estimation information. The vehicle driving system may be a system outputting a motor RPM value resulting from a predetermined torque value, when the predetermined torque value is input.

In analyzing the signal, the signal analyzer may be configured to perform preprocessing on the input motor torque value, and to determine at least one signal characteristic using a difference between the motor torque value on which the preprocessing is performed and the disturbance estimation information.

In performing the preprocessing, the signal analyzer may be configured to apply the LPF to the input motor torque value.

The signal characteristic may include one or more of a moving average, a variance, an amplitude, and a frequency of the signal.

The rough road determiner may be configured to determine the road surface as the rough road when one or more of the at least one signal characteristic, with respect to a signal value corresponding to a predetermined time window of the difference between the motor torque value on which the preprocessing is performed and the disturbance estimation information, is greater than a threshold value according to each signal characteristic.

The threshold value may be set based on a signal characteristic occurring when the vehicle travels on an asphalt road surface.

According to another aspect of the present disclosure, there is provided a system for determining a rough road, the system including a vehicle including at least one motor, a wheel, and an RPM measurement sensor, and a rough road determination apparatus configured to determine whether a road surface on which the vehicle travels is the rough road. The rough road determination apparatus may include a receiver configured to receive a motor torque value input to the vehicle and to receive, in real-time, motor RPM measurement information of the vehicle from the RPM measurement sensor, a disturbance calculator configured to determine disturbance estimation information using the input motor torque value and the motor RPM measurement information, a signal analyzer configured to analyze a signal using the disturbance estimation information, and a rough road determiner configured to determine whether the road surface on which the vehicle travels is the rough road using a result of analyzing the signal.

In determining the disturbance estimation information, the disturbance calculator may be configured to output preliminary estimation information by inputting the motor RPM measurement information to an inverse plant model of a vehicle driving system including the motor and the wheel of the vehicle, and to determine the disturbance estimation information by applying an LPF to a value obtained by subtracting the input motor torque value from the preliminary estimation information. The vehicle driving system may be a system outputting a motor RPM value resulting from a predetermined torque value, when the predetermined torque value is input.

In analyzing the signal, the signal analyzer may be configured to perform preprocessing by applying the LPF to the input motor torque value, and to determine at least one signal characteristic using a difference between the motor torque value on which the preprocessing is performed and the disturbance estimation information. The signal characteristic may include one or more of a moving average, a variance, an amplitude, and a frequency of the signal.

The rough road determiner may be configured to determine the road surface as the rough road when one or more of the at least one signal characteristic, with respect to a signal value corresponding to a predetermined time window of the difference between the motor torque value on which the preprocessing is performed and the disturbance estimation information, is greater than a threshold value according to each signal characteristic.

According to another aspect of the present disclosure, there is provided software or a computer-readable medium including executable instructions that, when executed by one or more processors, cause the one or more processors to perform a rough road determination method, and a computer program stored in the medium.

The features of the present disclosure briefly summarized above are merely exemplary aspects set forth in the following detailed description of the present disclosure, and are not intended to limit the scope of the present disclosure.

According to an exemplary embodiment of the present disclosure, a method and apparatus for determining a rough road, and a system including the apparatus may be provided.

In addition, according to an exemplary embodiment of the present disclosure, a method and apparatus configured for determining a rough road using a motor torque command and motor RPM information without a wheel speed sensor, and a system including the apparatus may be provided.

In addition, according to an exemplary embodiment of the present disclosure, a method and apparatus configured for determining a rough road without various pieces of prior data for training such as deep learning, machine learning or the like, and a system including the apparatus may be provided

However, the effects of the present disclosure are not limited to those set forth herein, and other effects set forth herein could be more easily understood by those skilled in the art from the description below.

### BRIEF DESCRIPTION OF DRAWINGS

The above and other aspects, features, and advantages of the present disclosure will be more clearly understood from the following detailed description, taken in conjunction with the accompanying drawings, in which:

FIGS. 1A and 1B are a diagram illustrating vibrations being transmitted to a motor when a vehicle travels on a road surface;

FIG. 2 is a diagram illustrating motor RPM information when a vehicle travels on a general asphalt road surface;

FIGS. 3A and 3B are a diagram illustrating motor RPM information when a vehicle travels on a rough road surface;

FIG. 4 is a flowchart illustrating a rough road determination method according to an exemplary embodiment of the present disclosure;

FIG. 5 is a diagram illustrating a process in which a rough road determination apparatus is configured to determine disturbance estimation information according to an exemplary embodiment of the present disclosure;

FIGS. 6A and 6B are a diagram illustrating a process in which a rough road determination apparatus is configured to perform preprocessing on an input motor torque command value according to an exemplary embodiment of the present disclosure;

FIG. 7 is a diagram illustrating a process in which a rough road determination apparatus is configured to determine whether a vehicle has travelled on a rough road using a result of analyzing a signal according to an exemplary embodiment of the present disclosure;

FIG. 8 is a diagram illustrating a rough road determination apparatus according to an exemplary embodiment of the present disclosure; and

FIG. 9 is a block diagram illustrating a computing device configured for fully or partially implementing a rough road determination apparatus according to an exemplary embodiment of the present disclosure.

### DETAILED DESCRIPTION

Hereinafter, example embodiments of the present disclosure will be described clearly and specifically so that a person skilled in the art easily could carry out example embodiments using the drawings. However, the present disclosure may be implemented in various different forms and is not limited to the example embodiments described herein.

In describing the example embodiments of the present disclosure, when it is determined that a detailed description of a known configuration or function may unnecessarily obscure the gist of the present disclosure, the detailed description thereof will be omitted. In the drawings, components not related to the description of the present disclosure are omitted, and similar reference numerals are used for similar components.

In the present disclosure, when it is stated that one component is “connected to,” “coupled to,” or “linked to” another component, such expressions may include not only direct connections, but also indirect connections via other components therebetween. In addition, when a component is described as “comprising,” “including,” or “having” another component, unless specifically stated otherwise, the component may not exclude the presence of additional components, but rather may further include other components.

In the present disclosure, the terms such as first, second, A, B, (a), (b), and the like may be used to distinguish a component from another component, and may not imply any particular order and/or importance, or others in relation to the components, unless otherwise specified. Accordingly, a “first component” in one exemplary embodiment may be referred to as a “second component” in another example embodiment, and vice versa.

In the present disclosure, mutually distinct components may be used to clearly describe respective characteristics, and such separation does not necessarily imply that the components are physically separated from each other. That is, a plurality of components may be integrated into a single hardware or software unit, or a single component may be distributed across a plurality of hardware or software units. Accordingly, integrated or distributed example embodiments, even if not explicitly stated, are also included within the scope of the present disclosure.

In the present disclosure, components described in various example embodiments do not necessarily indicate essential components, and some components may be optional components. Accordingly, an exemplary embodiment including a subset of the components described in one exemplary embodiment may also be included within the scope of the present disclosure. Furthermore, an exemplary embodiment including additional components in addition to the components described in various example embodiments is also included within the scope of the present disclosure.

Hereinafter, a method and apparatus for determining a rough road, and a system including the apparatus according to an exemplary embodiment of the present disclosure will be described with reference to the drawings.

Unlike asphalt, which generally has a relatively smooth surface, a rough road may refer to an uneven surface such as potholes, Belgian roads, or gravel roads. When a vehicle travels on a road surface, vibrations from the road surface may be transmitted in the order of a tire, a wheel, an axle, and a motor of the vehicle. According to an exemplary embodiment of the present disclosure, rough road determination and analysis using motor revolutions per minute (RPM) information may be performed, using the point that vibration characteristics of the road surface when the vehicle travels on the rough road are transmitted to a motor (driving system).

A rough road determination apparatus according to an exemplary embodiment of the present disclosure, which will be described below, may estimate characteristics of disturbance, caused by the rough road, being applied to the driving system using a motor torque value input to the vehicle and motor RPM information measured when the motor torque value is input. In addition, the rough road may be determined using a frequency, an amplitude, a moving average, and a variance value of reaction force of a corresponding road surface, based on disturbance information (reaction force information of the road surface) estimated as described above. When a front wheel motor and a rear wheel motor are respectively disposed in the vehicle, rough road determination may be performed using measured RPM information provided from each of the motors.

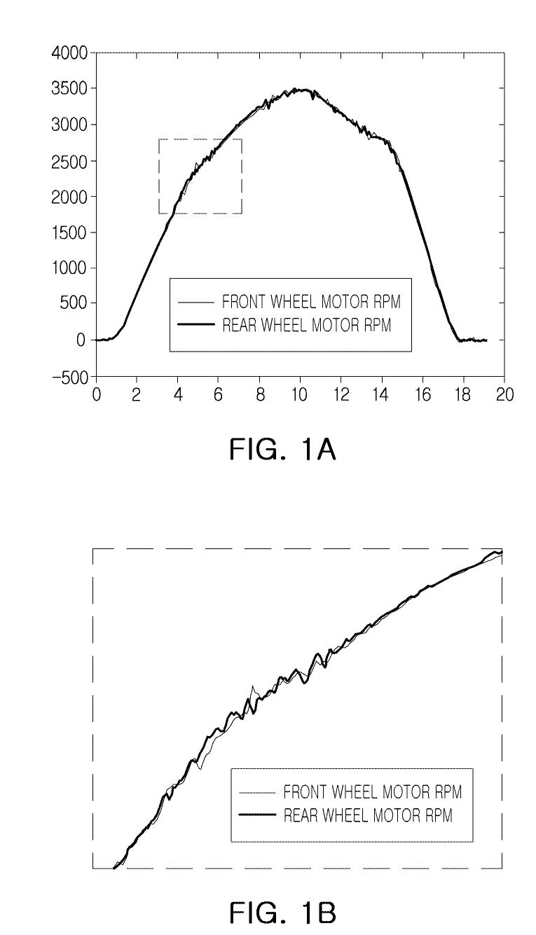

FIGS. 1A and 1B are diagrams illustrating vibrations being transmitted to a motor when a vehicle travels on a road surface.

FIG. 1A is a diagram illustrating motor RPM measurement information (Y-axis) of a vehicle over time (X-axis) when the vehicle travels on a rough road. FIG. 1B is an enlarged view of a portion indicated by a dotted line of FIG. 1A. RPM may refer to revolutions per minute, and may be represented in r/min. Time may be represented in seconds (sec).

Referring to FIGS. 1A and 1B, measured RPM information of a front wheel motor and measured RPM information of a rear wheel motor of the vehicle are represented by a light solid line and a thick solid line, respectively. It may be confirmed that, as the vehicle travels on the rough road, vibrations from the road surface are transmitted to a motor (driving system). That is, generally, when the vehicle travels on the rough road, it may be confirmed, through a wheel speed sensor measurement value, that vibrations are transmitted to a tire of the vehicle. However, referring to FIGS. 1A and 1B, it may be confirmed that such vibrations are transmitted even to the tire, axle, and driving system (motor).

A method and apparatus for determining a rough road according to an exemplary embodiment of the present disclosure may use RPM measurement information without directly using a wheel speed sensor value, and thus more robustly perform rough road estimation than when a wheel speed sensor is used. For example, when the wheel speed sensor is used, due to characteristics of the wheel speed sensor, the wheel speed sensor may recognize a situation unrelated to vibrations transmitted due to the rough surface, such as snow accumulation on a wheel. That is, the wheel speed sensor value may have a relatively high contamination frequency. In addition, the wheel speed sensor may be present on the outside of the vehicle as compared to the motor, and thus may have a relatively high failure frequency. Accordingly using the motor RPM measurement information as in the present exemplary embodiment may enable more robust rough road estimation than using the wheel speed sensor.

In the description of the present disclosure, the motor RPM measurement information may refer to an RPM measurement value of the vehicle over time, measured by an RPM measurement sensor of the vehicle.

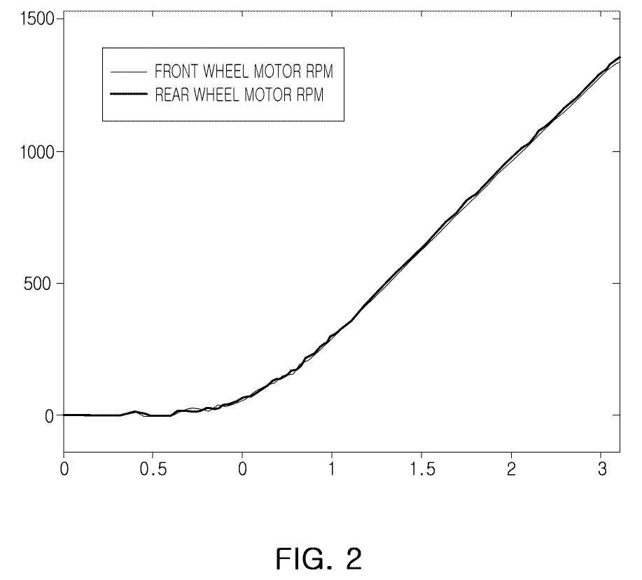

FIG. 2 is a diagram illustrating motor RPM information when a vehicle travels on a general asphalt road surface.

Referring to FIG. 2, it may be confirmed that when a vehicle travels on an asphalt road surface in a situation in which motors are disposed in a front wheel and a rear wheel of a vehicle, relatively large vibrations are not observed in each motor RPM measurement value. Even in the graph illustrated in FIG. 2, an X-axis may represent time (in seconds), and a Y-axis may represent an RPM measurement value (in r/min).

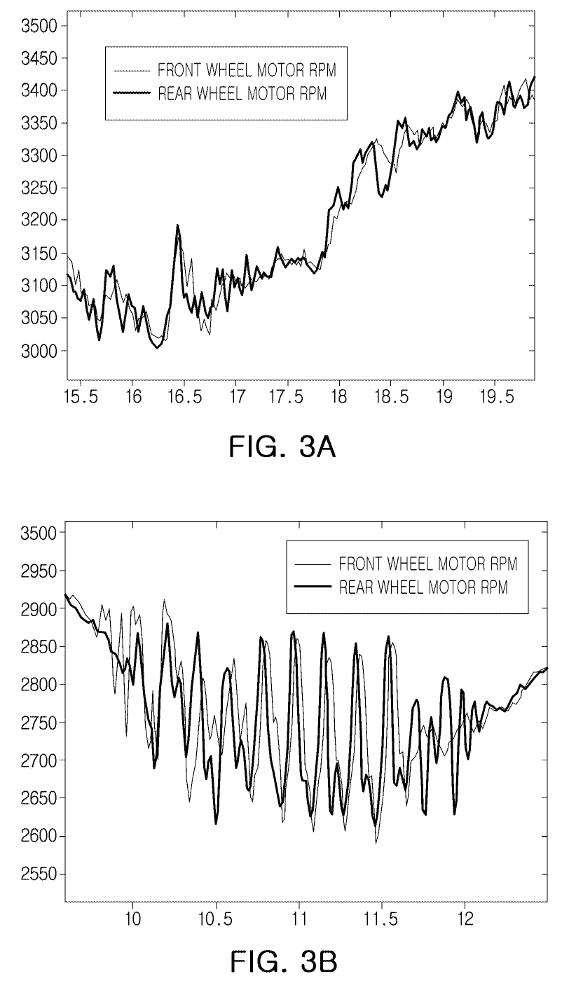

FIGS. 3A and 3B are diagrams illustrating motor RPM information when a vehicle travels on a rough road surface.

FIG. 3A is an example of a motor RPM measurement value of each of a front wheel and a rear wheel when a vehicle travels on a rough road surface including sand and gravel. In addition, FIG. 3B is an example of a motor RPM measurement value of each of a front wheel and a rear wheel when a vehicle travels on a rough road surface such as a washboard. Referring to FIGS. 3A and 3B, it may be seen that relatively large vibrations are transmitted to the motors, as compared to the motor RPM measurement value described above with reference to FIG. 2, when a vehicle travels on an asphalt road surface. In the graph illustrated in FIGS. 3A and 3B, an X-axis may represent time (in seconds), and a Y-axis may represent an RPM measurement value (in r/min).

According to a method and apparatus for determining a rough road according to an exemplary embodiment of the present disclosure, when there is a plurality of motors mounted on a vehicle, rough road determination using motor RPM values measured from all of the plurality of motors may be performed.

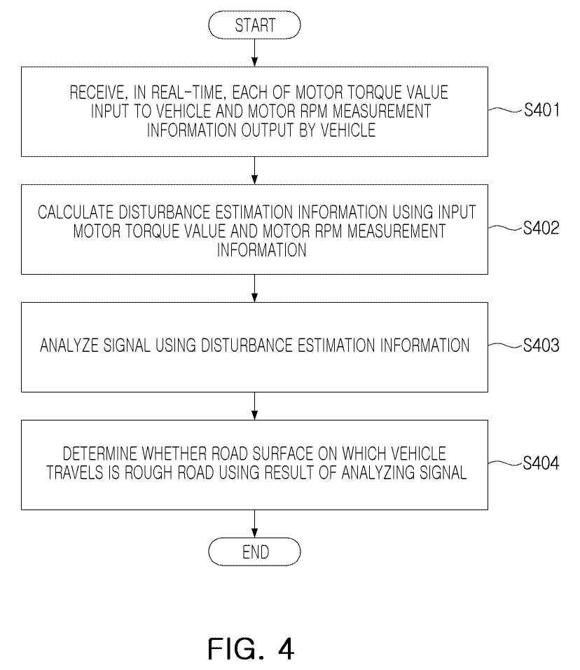

FIG. 4 is a flowchart illustrating a rough road determination method according to an exemplary embodiment of the present disclosure;

The rough road determination method illustrated in FIG. 4 may be performed by a rough road determination apparatus, which will be described below.

According to the rough rod determination method according to an exemplary embodiment of the present disclosure, a motor torque value input to a vehicle and motor RPM measurement information output by the vehicle may be received in real-time (S401). For example, the motor RPM measurement information may be received from an RPM measurement sensor configured for measuring the RPM of the vehicle. The motor torque value input to the vehicle may refer to a value input by a user (a driver or a designer) for motor control.

In addition, according to the rough road determination method according to an exemplary embodiment of the present disclosure, disturbance estimation information may be determined using the input motor torque value and motor RPM measurement information received in operation S401 (S402).

The disturbance estimation information may refer to an estimated value of a road surface friction reaction force value that arises from a rough road surface when the vehicle travels on a rough road. Alternatively, the disturbance estimation information may refer to an estimated value of a torque value obtained by multiplying the road surface friction reaction force value by a radius of a wheel.

Operation S402 may include an operation of outputting preliminary estimation information by inputting the motor RPM measurement information received in operation S401 to an inverse plant model of an actual driving system including a motor and a wheel of the vehicle, an operation of subtracting the input motor torque value of the vehicle received in operation S401 from the output preliminary estimation information, and an operation of outputting disturbance estimation information by applying a low pass filter (LPF) to a value obtained by subtracting the received input motor torque value of the vehicle from the preliminary estimation information.

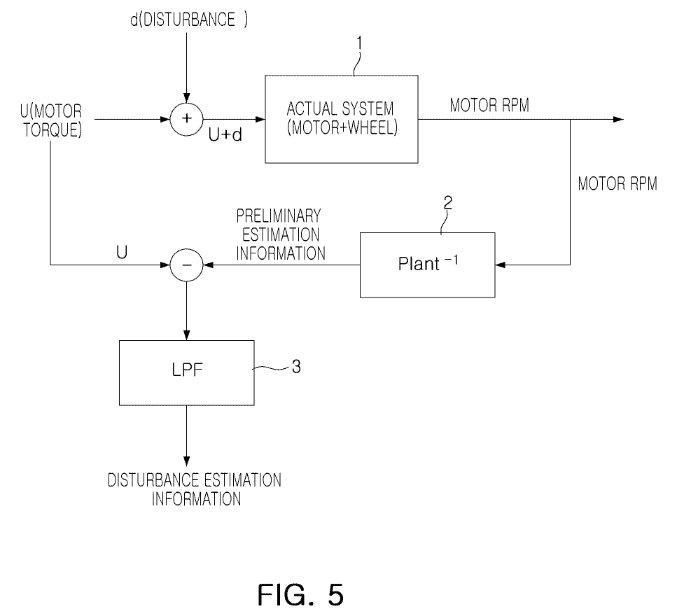

For example, when a predetermined motor torque value is input, the actual driving system may be a system outputting a motor RPM value corresponding to the motor torque value. A process of performing operation S402 will be described in more detail with reference to FIG. 5.

In addition, according to the rough road determination method according to an exemplary embodiment of the present disclosure, a signal may be analyzed using the disturbance estimation information determined in operation S402 (S403).

The signal analysis in operation S403 may be performed to determine whether the vehicle has travelled (or is travelling) on the rough road.

Operation S403 may be an operation in which at least one signal characteristic is analyzed by applying an LPF including a characteristic (for example, the same cutoff frequency) the same as that of the LPF used in operation S402 to the input motor torque value received in operation S401, and using a difference between the input motor torque value to which the LPF is applied and the disturbance estimation information in operation S402. For example, the signal characteristic may include one or more of a moving average, a variance, an amplitude, and a frequency of the signal, but the present disclosure is not limited thereto.

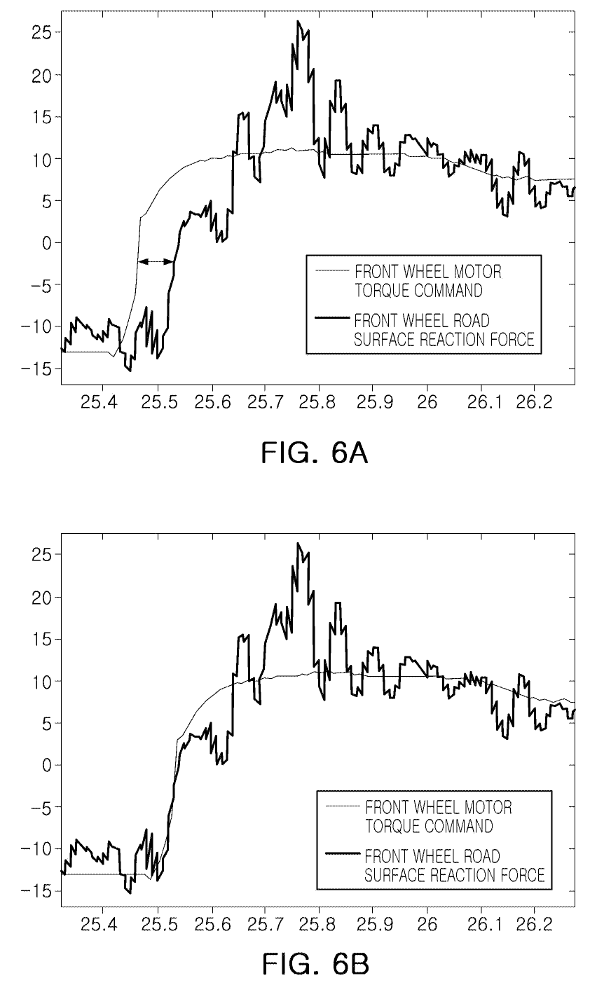

An LPF may be applied in the process of determining the disturbance estimation information described above. Thus, when comparing the input motor torque value of the vehicle with a magnitude of torque (N·m) over time (sec), a phase lag may inevitably occur. Accordingly, to compensate for the phase lag, in operation S403, an LPF including a cutoff frequency the same as that of the LPF applied in the process of determining the disturbance estimation information may be applied to the input motor torque value of the vehicle. In the description of the present disclosure, the process of applying the LPF to the input motor torque value may be referred to as a preprocessing process. In addition, the preprocessing process will be described in more detail with reference to FIGS. 6A and 6B.

In addition, according to the rough road determination method according to an exemplary embodiment of the present disclosure, a result of the signal analysis performed in operation S403 may be used to determine whether a road surface on which the vehicle travels is a rough road (S404).

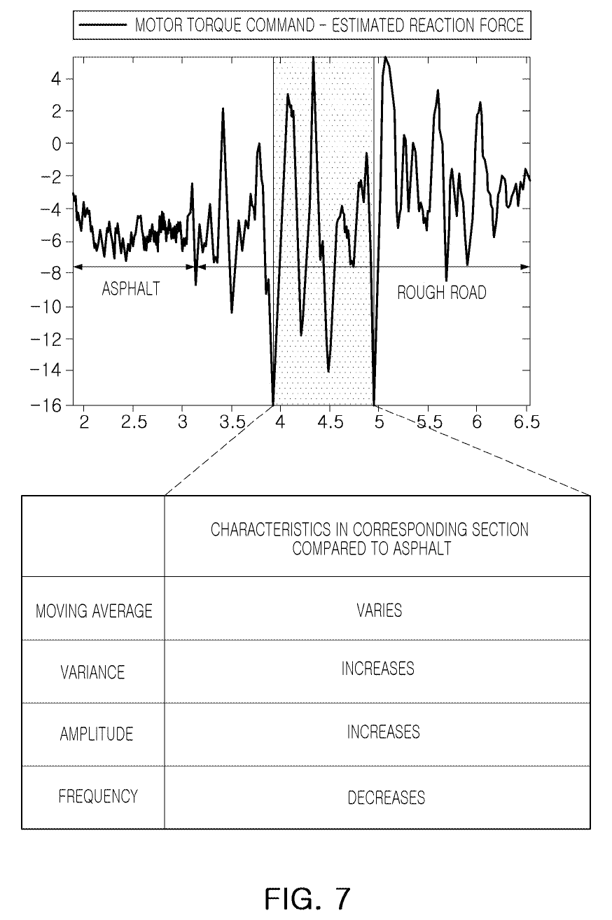

In operation S404, a predetermined time window may be set with respect to a torque signal over time, the torque signal being obtained by subtracting the disturbance estimation information from the input motor torque value of the vehicle on which preprocessing is performed, and determination of whether the road surface is the rough road may be performed using a signal characteristic of a corresponding data window. The signal characteristic may refer to one or more of a moving average, a variance, an amplitude, and a frequency. With respect to the above-described time window, when one or more of the signal characteristics is greater than a predetermined threshold value according to each signal characteristic, the road surface may be determined as the rough road. In addition, a reference for the threshold value may be set, for example, based on a relative magnitude difference from each signal characteristic (a moving average, a variance, an amplitude, or a frequency) when the vehicle travels on an asphalt road surface. Such a configuration will be described in more detail with reference to FIG. 7.

FIG. 5 is a diagram illustrating a process in which a rough road determination apparatus is configured to determine disturbance estimation information according to an exemplary embodiment of the present disclosure.

The description of FIG. 5 may be a detailed description of operation S402 described above with reference to FIG. 4. An input motor torque value U of a vehicle may be input to a driving system 1 (including a motor and a wheel) of the vehicle along with a disturbance d from a rough road surface. That is, even when a desired motor torque value is input, an actual system may include a disturbance d. Thus, the disturbance d may be included in a system input value, and such a result may be reflected in a motor RPM value.

That is, for the vehicle to move forward, a torque greater than a friction force of a road surface may need to be applied. In the instant case, when torque is applied to a motor, a significantly high RPM value may generally be output. However, in the actual system, due to a road surface friction reaction force value (disturbance) applied to a wheel, an unexpected result may be output.

The driving system 1 may output a motor RPM value, based on an input value, and the motor RPM value may be measured by a motor RPM measurement sensor of the vehicle. That is, the driving system 1 of the vehicle may be a system that, when a predetermined torque value is input, drives the motor based on the input torque value and outputs a motor RPM value.

The motor RPM measurement information may be input to an inverse plant model 2 of the driving system 1. As described above, the driving system 1 of the vehicle may be a system that, when a predetermined torque value is input, drives the motor based on the input torque value and outputs a motor RPM value, and thus the inverse plant model 2 may be a system that, when motor RPM information is input, outputs an estimated value of a torque value input to output a corresponding motor RPM. In the present disclosure, an output value of the inverse plant model 2 may be referred to as preliminary estimation information.

The preliminary estimation information may include estimated values of the input motor torque value U and the disturbance value d. Accordingly, according to an exemplary embodiment of the present disclosure, a process of subtracting the input motor torque value U from the preliminary estimation information may be performed. In addition, an LPF 3 may be applied to a value obtained by subtracting the input motor torque value U from the preliminary estimation information, finally determining disturbance estimation information.

FIG. 6 is a diagram illustrating a process in which a rough road determination apparatus is configured to perform preprocessing on an input motor torque command value according to an exemplary embodiment of the present disclosure.

FIG. 6 illustrates a process in which preprocessing is performed on an input motor torque value in operation S403 described above.

A front wheel road surface reaction force illustrated in FIG. 6 may be a value obtained by multiplying a road surface friction reaction force, which is generated by disturbance, by a radius of a wheel, and may be a value having the same unit (N·m) as torque. In addition, a front wheel motor torque command may refer to an input motor torque value applied to a front wheel of a vehicle. That is, in FIG. 6, an X-axis may represent time (sec), and a Y-axis may represent a magnitude of torque (N·m).

In FIGS. 6A and 6B, a front wheel motor torque command input value is represented by a thin line, and a front wheel road surface reaction force value is represented by a thick line. FIG. 6A illustrates a state before a preprocessing process (application of an LPF) is performed on the front wheel motor torque command, and FIG. 6B illustrates a result of performing phase compensation by performing preprocessing on the front wheel motor torque command value.

As illustrated in FIG. 6A, in estimating disturbance, the LPF 3 may be applied in a final operation, it may be confirmed that a slight phase lag is present when compared with the front wheel motor torque command value. Accordingly, as illustrated in FIG. 6B, a preprocessing process may be performed to compensate for a phase, by applying a LPF including a cutoff frequency the as that of the LPF applied during disturbance estimation to the front wheel motor torque command value.

FIG. 7 is a diagram illustrating a process in which a rough road determination apparatus is configured to determine whether a vehicle has travelled on a rough road using a result of analyzing a signal according to an exemplary embodiment of the present disclosure.

FIG. 7 may be a diagram illustrating operation S404 described above. A graph illustrated in FIG. 7 may represent a signal value obtained by subtracting an estimated value of road surface reaction force value (disturbance estimation information) from an input motor torque command value, after preprocessing (application of an LPF) is performed on a front-wheel motor torque command value, as illustrated in FIG. 6B. That is, an X-axis of the graph illustrated in FIG. 7 may represent time (in seconds), and a Y-axis may represent a magnitude of torque (in N·m).

Referring to FIG. 7, it may be confirmed that when a vehicle travels on a rough road, the graph has a relatively large amplitude, as compared to when the vehicle travels on an asphalt road. For example, as illustrated in FIG. 7, an arbitrary data window (time window) may be set. It may be determined whether the vehicle has travelled on the rough road, based on whether a signal characteristic (for example, a moving average, a variance, an amplitude, and a frequency) of the data window is greater than a threshold value. The threshold value may be set based on a comparison value with a signal characteristic in an asphalt road surface section. That is, as illustrated by a gray-shaded region in FIG. 7, a data window may be set. It may be determined whether the vehicle has travelled on the rough road based on how signal characteristics of the data window differ from those of the asphalt road surface. It may be observed that the moving average varies, the variance and amplitude increase, and the frequency decreases, and thus it may be determined that the vehicle travelled on the rough road during a corresponding time period. The time window illustrated in FIG. 7 may be arbitrarily set by a user (for example, a designer). In FIG. 7, it is illustrated that all four signal characteristics are considered. In some exemplary embodiments of the present disclosure, determination whether the vehicle has travelled on the rough road may be performed using fewer signal characteristics. Furthermore, the signal characteristics are not limited to those described above.

According to another example embodiment, rough road determination may be performed on a corresponding time window (data window) by performing frequency domain analysis using Fast Fourier Transform (FFT) or the like.

According to another example embodiment, the comparison of signal characteristics with those of the asphalt road surface illustrated in FIG. 7 may be performed using various machine learning techniques based on training.

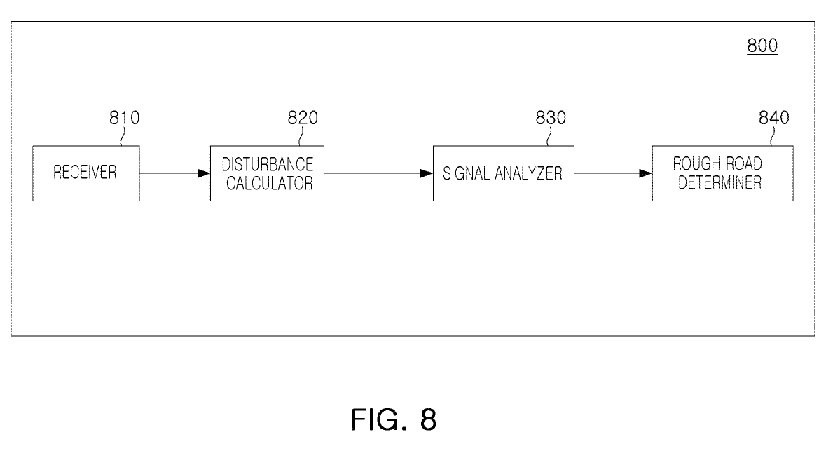

FIG. 8 is a diagram illustrating a rough road determination apparatus according to an exemplary embodiment of the present disclosure.

Referring to FIG. 8, a rough road determination apparatus 800 according to an exemplary embodiment may include a receiver 810, a disturbance calculator 820, a signal analyzer 830, and a rough road determiner 840, but the present disclosure is not limited thereto. Furthermore, all or part of the components illustrated in FIG. 8 may be configured as a single component, or may be additionally configured as separate components.

The receiver 810 may receive, in real-time, each of a motor torque value input to a vehicle and RPM measurement information output by the vehicle. For example, the receiver 810 may receive the motor RPM measurement information from an RPM measurement sensor.

The disturbance calculator 820 may be configured to determine disturbance estimation information using the input motor torque value and the motor RPM measurement information. For example, in determining the disturbance estimation information, the disturbance calculator 820 may output preliminary estimation information by inputting the motor RPM measurement information to an inverse plant model of a vehicle driving system including a motor and a wheel of the vehicle; and may be configured to determine the disturbance estimation information by applying an LPF to a value obtained by subtracting the input motor torque value from the preliminary estimation information. In addition, the above-described vehicle driving system may be a system outputting a motor RPM value resulting from a predetermined torque value, when the predetermined torque value is input.

The signal analyzer 830 may analyze a signal using the disturbance estimation information. For example, in analyzing the signal, the signal analyzer 830 may perform preprocessing on the input motor torque value, and may be configured to determine at least one signal characteristic using a difference between the motor torque value on which the preprocessing is performed and the disturbance estimation information. Furthermore, the signal characteristic may include one or more of a moving average, a variance, an amplitude, and a frequency of the signal.

The rough road determiner 840 may be configured to determine whether a road surface on which the vehicle travels is a rough road using a result of analyzing the signal. The rough road determiner 840 may be configured to determine the road surface as the rough road when one or more of the at least one signal characteristic, with respect to a signal value corresponding to a predetermined time window of the difference between the motor torque value on which the preprocessing is performed and the disturbance estimation information, is greater than a threshold value according to each signal characteristic. For example, the threshold value may be set based on a signal characteristic occurring when the vehicle travels on an asphalt road surface.

According to another exemplary embodiment of the present disclosure, a rough road determination system including the above-described rough road determination apparatus 800 may be provided. The rough road determination system according to an exemplary embodiment may include a vehicle including at least one motor, a wheel, and an RPM measurement sensor, and a rough road determination apparatus configured to determine whether a road surface on which the vehicle travels is a rough road.

The rough road determination apparatus 800 may include a receiver 810 configured to receive a motor torque value input to the vehicle and to receive, in real-time, motor RPM measurement information of the vehicle from the RPM measurement sensor, a disturbance calculator 820 configured to determine disturbance estimation information using the input motor torque value and the motor RPM measurement information, a signal analyzer 830 configured to analyze a signal using the disturbance estimation information, and a rough road determiner 840 configured to determine whether the road surface on which the vehicle travels is the rough road using a result of analyzing the signal.

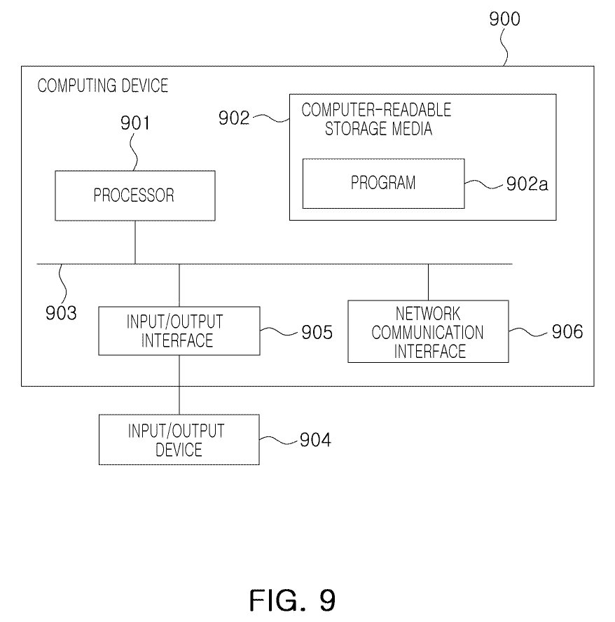

FIG. 9 is a block diagram illustrating a computing device configured for fully or partially implementing a rough road determination apparatus according to an exemplary embodiment of the present disclosure.

FIG. 9 is a block diagram illustrating a computing device 900 configured for fully or partially implementing a rough road determination apparatus 800 according to an exemplary embodiment of the present disclosure, and may include all or part of the rough road determination apparatus 800 illustrated in FIG. 8.

As illustrated in FIG. 9, the computing device 900 may include at least one processor 901, a computer-readable storage medium 902, and a communication bus 903.

In one example, the processor 901 may cause the computing device 900 to operate according to the example embodiments described above. For example, the processor 901 may execute one or more programs stored in the computer-readable storage medium 902. The one or more programs may include one or more computer-executable instructions. When executed by the processor 901, the one or more computer-executable instructions may be configured to cause the computing device 900 to perform operations according to example embodiments. In another example, the processor 901 of the computing device 900 of FIG. 9 may be capable of implementing the functions of the different units of the rough road determination apparatus 800 of FIG. 8, or causing the different units to perform their respective functions.

The computer-readable storage medium 902 may be configured to store the computer-executable instructions or program code, program data, and/or other suitable forms of information. A program 902a, stored in the computer-readable storage medium 902, may include a set of instructions executable by the processor 901. In an example embodiment, the computer-readable storage medium 902 may be a memory (a volatile memory such as a random access memory, a non-volatile memory, or any suitable combination thereof), one or more magnetic disk storage devices, optical disk storage devices, flash memory devices, other types of storage media that are accessible by the computing device 900 and are configured for storing desired information, or any suitable combinations thereof.

The communication bus 903 may interconnect various other components of the computing device 900, including the processor 901 and the computer-readable storage medium 902.

The computing device 900 may also include one or more input/output interfaces 905 providing an interface for one or more input/output devices 904, and one or more network communication interfaces 906. The input/output interface 905 and the network communication interface 906 may be connected to the communication bus 903.

The network communication interface 906 may be an interface for in-vehicle communication or an interface for communication between a vehicle and a device other than the vehicle, and may include, for example, a Controller Area Network (CAN), a Media Oriented Systems Transport (MOST) network, a Local Interconnect Network (LIN), and/or X-by-Wire (Flexray), Wi-Fi, Bluetooth, NFC, or RFID. A network may be one of a cellular network, for example, a global system for mobile communications (GSM), an enhanced data rate for GSM evolution (EDGE), a general packet radio service (GPRS), a Code Division Multiple Access (CDMA), a time division-CDMA (TD-CDMA), a Universal Mobile Telecommunications System (UMTS), or long-term evolution (LTE), or another cellular network.

The input/output device 904 may be connected to other components of the computing device 900 through the input/output interface 905. The exemplary input/output device 904 may include a pointing device (such as a mouse or trackpad), a keyboard, a touch input device (such as a touchpad or touchscreen), a voice or sound input device, input devices such as various types of sensor devices and/or photographing devices, and/or output devices such as a display device, a printer, a speaker, and/or a network card. The exemplary input/output device 904 may be included in the computing device 900 as a component included in the computing device 900, or may be connected to the computing device 900 as a device, distinct from the computing device 900.

Exemplary methods of the present disclosure are referred to as a series of operations for clarity of description; however, the order of operations is not intended to be limiting. Respective operations may be performed simultaneously or in a different order, if necessary. To implement the method according to an exemplary embodiment of the present disclosure, additional operations may be included in addition to exemplary operations, some operations may be excluded, or some operations may be excluded and other additional operations may be included.

Various example embodiments of the present disclosure are not intended to list all possible combinations, but are intended to describe representative aspects of the present disclosure. The features described in the various example embodiments may be applied independently or in combination of two or more.

In addition, the various example embodiments of the present disclosure may be implemented in hardware, firmware, software, or a combination thereof. In the case of hardware implementation, the example embodiments may be implemented using one or more application-specific integrated circuits (ASICs), digital signal processors (DSPs), digital signal processing devices (DSPDs), programmable logic devices (PLDs), field-programmable gate arrays (FPGAs), general processors, controllers, microcontrollers, or microprocessors.

The scope of the present disclosure includes software or machine-executable instructions (for example, operating systems, applications, firmware, programs) that cause operations according to methods of the various example embodiments to be executed on a device or computer, and non-transitory computer-readable media in which the software or instructions are stored and which are executable on a device or computer.

While example embodiments have been shown and described above, it will be apparent to those skilled in the art that modifications and variations could be made without departing from the scope of the present disclosure as defined by the appended claims.

What is claimed is:

1. A method for determining a rough road, the method comprising:
receiving, in real-time, each of a motor torque value input to a vehicle and motor revolutions per minute (RPM) measurement information output by the vehicle;
determining disturbance estimation information using the input motor torque value and the motor RPM measurement information;
analyzing a signal using the disturbance estimation information; and
determining whether a road surface on which the vehicle travels is the rough road using a result of analyzing the signal.

2. The method of claim 1, wherein the motor RPM measurement information is received from an RPM measurement sensor.

3. The method of claim 1,
wherein the determining of the disturbance estimation information includes:
outputting preliminary estimation information by inputting the motor RPM measurement information to an inverse plant model of a vehicle driving system including a motor and a wheel of the vehicle; and
determining the disturbance estimation information by applying a low pass filter (LPF) to a value obtained by subtracting the input motor torque value from the preliminary estimation information, and
wherein the vehicle driving system is a system outputting a motor RPM value resulting from a predetermined torque value, based on that the predetermined torque value is input.

4. The method of claim 3, wherein the analyzing of the signal includes:
performing preprocessing on the input motor torque value; and
determining at least one signal characteristic using a difference between the motor torque value on which the preprocessing is performed and the disturbance estimation information.

5. The method of claim 4, wherein the performing of the preprocessing includes applying the LPF to the input motor torque value.

6. The method of claim 4, wherein the at least one signal characteristic includes one or more of a moving average, a variance, an amplitude, and a frequency of the signal.

7. The method of claim 4, wherein the determining of whether the road surface on which the vehicle travels is the rough road includes determining the road surface as the rough road based on that one or more of the at least one signal characteristic, with respect to a signal value corresponding to a predetermined time window of the difference between the motor torque value on which the preprocessing is performed and the disturbance estimation information, is greater than a threshold value according to each signal characteristic.

8. The method of claim 7, wherein the threshold value is set based on a signal characteristic occurring when the vehicle travels on an asphalt road surface.

9. An apparatus for determining a rough road, the apparatus comprising:
a receiver configured to receive, in real-time, each of a motor torque value input to a vehicle and revolutions per minute (rpm) measurement information output by the vehicle;
a disturbance calculator configured to determine disturbance estimation information using the input motor torque value and the motor RPM measurement information;
a signal analyzer configured to analyze a signal using the disturbance estimation information; and
a rough road determiner configured to determine whether a road surface on which the vehicle travels is the rough road using a result of analyzing the signal.

10. The apparatus of claim 9, wherein the receiver is configured to receive the motor RPM measurement information from an RPM measurement sensor.

11. The apparatus of claim 9,
wherein in determining the disturbance estimation information, the disturbance calculator is configured to:
output preliminary estimation information by inputting the motor RPM measurement information to an inverse plant model of a vehicle driving system including a motor and a wheel of the vehicle; and
determine the disturbance estimation information by applying a low pass filter (LPF) to a value obtained by subtracting the input motor torque value from the preliminary estimation information, and
wherein the vehicle driving system is a system outputting a motor RPM value resulting from a predetermined torque value, based on that the predetermined torque value is input.

12. The apparatus of claim 11, wherein in analyzing the signal, the signal analyzer is configured to:
perform preprocessing on the input motor torque value; and
determine at least one signal characteristic using a difference between the motor torque value on which the preprocessing is performed and the disturbance estimation information.

13. The apparatus of claim 12, wherein in performing the preprocessing, the signal analyzer is configured to apply the LPF to the input motor torque value.

14. The apparatus of claim 12, wherein the at least one signal characteristic includes one or more of a moving average, a variance, an amplitude, and a frequency of the signal.

15. The apparatus of claim 12, wherein the rough road determiner is configured to determine the road surface as the rough road based on that one or more of the at least one signal characteristic, with respect to a signal value corresponding to a predetermined time window of the difference between the motor torque value on which the preprocessing is performed and the disturbance estimation information, is greater than a threshold value according to each signal characteristic.

16. The apparatus of claim 15, wherein the threshold value is set based on a signal characteristic occurring when the vehicle travels on an asphalt road surface.

17. A system for determining a rough road, the system comprising:
a vehicle including at least one motor, a wheel, and revolutions per minute (rpm) measurement sensor; and
a rough road determination apparatus configured to determine whether a road surface on which the vehicle travels is the rough road,
wherein the rough road determination apparatus includes:
a receiver configured to receive a motor torque value input to the vehicle and to receive, in real-time, motor RPM measurement information of the vehicle from the RPM measurement sensor;
a disturbance calculator configured to determine disturbance estimation information using the input motor torque value and the motor RPM measurement information;
a signal analyzer configured to analyze a signal using the disturbance estimation information; and
a rough road determiner configured to determine whether the road surface on which the vehicle travels is the rough road using a result of analyzing the signal.

18. The system of claim 17,
wherein in determining the disturbance estimation information, the disturbance calculator is configured to:
output preliminary estimation information by inputting the motor RPM measurement information to an inverse plant model of a vehicle driving system including the at least one motor and the wheel of the vehicle; and
determine the disturbance estimation information by applying a low pass filter (LPF) to a value obtained by subtracting the input motor torque value from the preliminary estimation information, and
wherein the vehicle driving system is a system outputting a motor revolutions per minute (rpm) value resulting from a predetermined torque value, based on that the predetermined torque value is input.

19. The system of claim 18,
wherein in analyzing the signal, the signal analyzer is configured to:
perform preprocessing by applying the LPF to the input motor torque value; and
determine at least one signal characteristic using a difference between the motor torque value on which the preprocessing is performed and the disturbance estimation information, and
wherein the at least one signal characteristic includes one or more of a moving average, a variance, an amplitude, and a frequency of the signal.

20. The system of claim 19, wherein the rough road determiner is configured to determine the road surface as the rough road based on that one or more of the at least one signal characteristic, with respect to a signal value corresponding to a predetermined time window of the difference between the motor torque value on which the preprocessing is performed and the disturbance estimation information, is greater than a threshold value according to each signal characteristic.
